(19) United States
(12) Patent Application Publication
(10) Pub. No.: US 2012/0198834 A1
(43) Pub. Date: Aug. 9, 2012

(54) THERMODYNAMIC MACHINE WITH STIRLING CYCLE

(75) Inventor: Pierre Charlat, Lans En Vercors (FR)

(73) Assignee: Stiral, Corenc (FR)

(21) Appl. No.: 13/496,673

(22) PCT Filed: Sep. 21, 2010
(86) PCT No.: PCT/FR10/51973

§ 371 Date: Apr. 24, 2012

(30) Foreign Application Priority Data
Sep. 21, 2009 (FR) 0956472

(51) Int. Cl. F01B 29/10; F02G 1/044

(52) U.S. Cl. 60/525

(57) ABSTRACT

A thermodynamic machine is made up of at least one assembly of two elementary Stirling cycle machines symmetrically formed in one or more cylindrical bodies with the same axis, each elementary machine including first and second compression/expansion chambers, a regenerator separating the first and second chambers and first and second outer walls intended for sealing the volume of the first and second chambers respectively, the regenerator and the first and second outer walls of one elementary machine being rigidly connected to the same elements of the other elementary machines.

### FIELD OF THE INVENTION

The present invention generally relates to Stirling-cycle thermodynamic machines. More specifically, the present invention relates to machine where power losses are limited.

### DISCUSSION OF PRIOR ART

Stirling machines are used for industrial refrigeration and in military or space applications. Such machines have the advantage of being usable as motors or to generate heat or cold without the use of refrigerants, which are generally polluting. Another advantage of a Stirling machine is that its hot source is external and that this source can thus be obtained by means of any known fuel type, or even solar radiation.

In a Stirling cycle, a gas, for example, air, nitrogen, hydrogen, or helium, is submitted to a four-phase cycle: an isochoric heating, an isothermal expansion, an isochoric cooling, and an isothermal compression.

FIG. 1 is a generic diagram of a Stirling machine. A first chamber 3 is connected to a second chamber 5 via a first heat exchanger 7, a regenerator 9, and a second heat exchanger 11. The assembly comprised of the chambers, the exchangers, and the regenerator may be cylindrical. First and second exchangers 7 and 11 are respectively in contact with a hot source at a hot temperature T_{C} and with a cold source at a cold temperature T_{F}. For example, the cold source may be a source close to the ambient temperature and the hot source may be a much hotter thermally-isolated source. In the general case which is considered herein, the exchangers are connected to the hot and cold sources via heat transfer fluids flowing through ducts and set in motion, for example, by means of pumps (see hereinafter).

Chambers 3 and 5 are respectively closed by moving pistons 13 and 15 which define the variable volumes of chambers 3 and 5. It should be understood that there are different ways for the different elements of the Stirling machine shown in FIG. 1 to be mobile with respect to one another: for example, the two pistons 13 and 15 may be mobile and regenerator 9 and exchangers 7 and 11 may be fixed, in the case of a so-called alpha configuration. One of pistons 13 or 15 may also be fixed if the central portion (regenerator) of the machine is mobile. The assembly formed of regenerator 9 and of exchangers 7 and 11 may also be provided to be fixed and the variable volumes of chambers 3 and 5 may be defined by a single volume divided in two by a mobile wall, called a displacer. Such a configuration is generally called beta configuration.

FIGS. 2A to 2D illustrate steps of a Stirling machine cycle.

In an initial arbitrary state A illustrated in FIG. 2A, a gas volume is stored in first chamber 3, second chamber 5 having a zero or very low volume.

The gas in first chamber 3 is heated by the hot source and its pressure increases. This displaces piston 13 to a state B (FIG. 2B) in which the volume taken up by the gas in chamber 3 is greater than the volume of this same chamber at state A. During the isothermal expansion phase (steps A to B), mechanical work is extracted.

An isochoric cooling then enables to pass from state B to a state C in which the gas in hot chamber 3 is transferred into cold chamber 5. During this transfer, the gas stored in chamber 3 crosses regenerator 9 and has cooled down as it reaches chamber 5. The heat contained in the hot gas is “extracted” in the regenerator and the gas cools down.

An isothermal compression enables to pass from state C to a state D in which the volume taken up by the gas in chamber 5 is smaller than the volume of this same chamber at state C. This compression is performed by actuating piston 15 to decrease the volume of chamber 5. This step consumes mechanical power, but less than the power provided in the expansion between states A and B.

Finally, an isochoric transfer enables to pass from state D to initial state A in which the gas is stored in hot chamber 3. During this step, the gas passes from cold chamber 5 to hot chamber 3 via regenerator 9. In the regenerator, the heat extracted during the isochoric cooling (steps B to C) is given back to the gas as it passes through the regenerator for the second time (steps D to A). Thus, the gas heats up before coming in contact with exchanger 7. It should be noted that, in known machines, chambers 3 and 5 alternately almost totally empty during the cycle.

In machine cycle, the mechanical work extracted during the expansion between steps A and B is partly used for the isothermal compression. The regenerator enables the heat extracted during the passing from state B to state C to be distributed to the gas during the passing from state D to state A and avoids thermal losses due to hot gas entering the cold chamber and conversely (it avoids irreversibility). Indeed, the regenerator operates as follows: when a hot gas goes through a cold regenerator, it cools down while heating up the regenerator and, conversely, a cold gas crossing the hot regenerator heats up while cooling down the regenerator. To perform its function, the regenerator must be made of materials which are poor heat conductors in the gas flow direction, for example, thermally isolating materials, to avoid a direct transmission of heat between portions at different temperatures.

Machines which are desired to be reversible, that is, capable of being used in machine cycle or in heat pump cycle, are considered herein. It should be noted that this definition of reversibility differs from the current definition, for which a reversible machine is a machine with cold and hot sources which may be inverted.

Currently, Stirling cycle machines have an efficiency which could be improved. This is due to many sources of losses which appear in such machines, especially at the level of heat exchanges between heat transfer fluids and the working gas and at the mechanical drive level.

Thus, the present inventor has searched and identified the different sources of losses and has provided solutions to decrease them.

### Summary

An object of an embodiment of the present invention is to provide a Stirling cycle thermodynamic machine where the different power losses are decreased.

Another object of an embodiment of the present invention is to provide a Stirling cycle thermodynamic machine formed of two elementary machines operating in phase opposition.

Thus, an embodiment of the present invention provides a thermodynamic machine formed of at least one assembly of two elementary Stirling cycle machines formed symmetrically in at least one or several cylindrical bodies of same axis, each elementary machine comprising first and second compression/expansion chambers, a regenerator separating the first and second chambers, and first and second external walls intended to close the volume, respectively, of the first and second chambers, the re-generator, the first and second external walls of an elementary machine being rigidly connected to the same elements of the other elementary machines.

According to an embodiment of the present invention, each first external wall is mobile in the body, each second external wall is fixed with respect to the body, and each regenerator is mobile in the body.

According to an embodiment of the present invention, two regenerators of two elementary machines formed in a same body are interconnected via an axis located at the center of the body and the first external walls are rigidly interconnected via one or several bars extending outside of the body.

According to an embodiment of the present invention, the first and second compression/expansion chambers are divided by first and second partitions axially extending, respectively, from the associated external wall and from the regenerator, the first and second partitions becoming interleaved in the relative motions between said first and second partitions.

According to an embodiment of the present invention, the assembly formed of an external wall and of the associated partitions is formed by winding of a wide strip and of at least one narrower strip having a width corresponding to the width of the external walls, the narrower strip being perforated along its entire width except where it is in contact with the chamber, the wide strip being perforated on its portion located at the level of the perforated width of the narrower strip.

According to an embodiment of the present invention, the machine further comprises pieces associated with the first and second walls, outside of the compression/expansion chambers, in which channels enabling to bring a heat transfer fluid into the holes formed in the winding are defined.

According to an embodiment of the present invention, each regenerator is delimited by two permeable internal walls from which partitions axially extend into the regenerator enclosure, each internal wall and its associated partitions being formed by winding of a wide strip and of at least one narrower strip having a width corresponding to the width of the regenerator walls, the narrower strip comprising, widthwise, a first corrugated area having oblique corrugations with respect to the strip length, a second planar area, and a third corrugated area having oblique corrugations with respect to the strip length in a direction opposite to the corrugations of the first area, the wide strip comprising, facing the first and third areas of the narrower strip in the winding, corrugated areas having oblique corrugations with respect to the length of the wide strip, in a reverse direction with respect to the corrugations of the narrower strip.

According to an embodiment of the present invention, each elementary machine further comprises a cylindrical piece capable of moving along with the regenerator, formed around the regenerator in the body.

According to an embodiment of the present invention, the body comprises extensions delimiting first back chambers of each elementary machine, opposite to the second compression/expansion chambers with respect to the first external walls, the back chambers of each elementary machine being in direct communication through a duct.

According to an embodiment of the present invention, a first heat transfer fluid flows in and out of each first back chamber via ducts in which check valves are formed in the direction of circulation of the first heat transfer fluid, the motion of the first external walls with respect to the ducts ensuring the pumping of the heat transfer fluid into the ducts.

According to an embodiment of the present invention, the body comprises an extension delimiting a second back chamber, opposite to the second chambers with respect to the second external walls.

According to an embodiment of the present invention, a second heat transfer fluid flows in and out of the second back chamber via ducts in which check valves are formed in the direction of circulation of the second heat transfer fluid.

According to an embodiment of the present invention, the machine comprises a combustion chamber in the second back chamber, in contact with the second external walls.

According to an embodiment of the present invention, the first external walls are rigidly connected to the foot of a first connecting rod having its head associated with a first crankshaft and the regenerators are rigidly connected to the foot of a second connecting rod having its head associated with a second crankshaft, the first and second crankshafts being formed around a same axis.

### BRIEF DESCRIPTION OF THE DRAWINGS

The foregoing and other objects, features, and advantages of the present invention will be discussed in detail in the following non-limiting description of specific embodiments in connection with the accompanying drawings, among which:

FIG. 1, previously described, is a generic diagram of a Stirling machine;

FIGS. 2A to 2D, previously described, illustrate steps of a Stirling cycle;

FIG. 3 is a simplified cross-section view of an example of the structure of a Stirling cycle machine;

FIG. 4 illustrates an example of the structure of two half-exchangers of the machine of FIG. 3;

FIG. 5 is a simplified flowchart of an elementary machine according to an embodiment of the present invention;

FIG. 6 is a simplified cross-section view illustrating a machine formed of two elementary thermodynamic machines according to an embodiment of the present invention;

FIGS. 7A to 7F show steps of a cycle using the machine of FIG. 6;

FIG. 8 illustrates an example of two half-exchangers according to an embodiment of the present invention;

FIGS. 9A, 9B, and 9C illustrate elements of FIG. 8 in further detail;

FIGS. 10 and 11 are two more detailed cross-section views of the machine of FIG. 6; and

FIG. 12 illustrates a thermodynamic machine comprising four elementary Stirling cycle machines according to an embodiment of the present invention.

For clarity, the same elements have been designated with the same reference numerals in the different drawings. Further, the various drawings are not to scale.

### DETAILED DESCRIPTION

To increase the efficiency of Stirling cycle machines, it is necessary to identify the different sources of losses which appear in these machines, and then to provide solutions to limit such losses.

### 1. Compression-Expansion Chambers and Exchangers

Losses first appear in the compression/expansion chambers where temperature differences appear during the compressions and expansions which should theoretically be isothermal. Indeed, in a conventional case where each compression/expansion chamber is formed of a volume delimited by mobile walls, the most part of the gas undergoes a transformation which is not isothermal. Thus, the gas is at a temperature different from that of the corresponding hot or cold exchanger.

A second source of losses is conventionally due to temperature differences appearing within each exchanger, due to the thermal resistance of the materials forming these exchangers.

To limit these two types of losses, machines are formed, where the compression/expansion chambers are directly associated with the hot and cold sources and are delimited by mobile transverse walls having axial partitions, which become interleaved when the volume of the chambers decreases, extending from them. Thus, each compression/expansion chamber is delimited by a first external wall and by a second wall connected to the regenerator, the thermal exchanges with the hot or cold source taking place at the level of the external wall. It should be noted that, hereinafter, “wall” or “internal wall” will be used to designate a piece delimiting a compression/expansion chamber on the regenerator side, although this piece is not tight and is provided to let through the gas in an axial direction. Further, hereinafter, “exchanger” will be used to designate a compression/expansion chamber intended to receive power from a hot source or from a cold source. The first and second walls, as well as their associated partitions, will be called “half-exchanger” hereinafter.

On the one hand, the forming of axial walls in the compression/expansion chambers enables the gas temperature not to become different from that of the exchanger during the compression/expansion and, on the other hand, the reciprocating motion of the walls enables to transfer heat all the way to the heart of the exchange structure and avoids temperature variations in the exchangers, even in the case where the partitions are made of a poorly conductive material, such as certain steels.

FIG. 3 is a detailed cross-section view of the body of such a Stirling-cycle machine.

The machine is for example formed in a tight cylinder 21 and comprises a first chamber 23 and a second chamber 25 separated by a regenerator 27. An exchanger, formed of two half-exchangers, is formed in each of chambers 23 and 25. A first impermeable transverse external wall 33, respectively 35, having axial partitions 29, respectively 31, extending from it, forms a first half-exchanger in chamber 23, respectively 25. A second internal wall 41, respectively 43, connected to regenerator 27, having axial partitions 37, respectively 39, extending from it, forms a second half-exchanger in chamber 23, respectively 25. Internal walls 41 and 43 delimit the location of the regenerator and let through the gas.

In the shown example, regenerator 27 comprises axial partitions 45, 47 which respectively extend from walls 41 and 43. Partitions 45 and 47 are shown in interleaved configuration, for example, with a shape identical to that of partitions 29 and 37 or 31 and 39, and are preferably made of a material which is a poor thermal conductor but has good properties of thermal exchange with the gas, that is, a sufficient thermal effusivity. For example, partitions 45 and 47 may be made of polycarbonate. Guides parallel to the gas flow may be added in the regenerator to ensure for the gas transiting therethrough to follow the same path in both displacement directions. It should be noted that the regenerator structure described herein is an example only and that any known regenerator type may be used in the machine of FIG. 3.

In the shown example, the machine is formed around a central shaft 49. Shaft 49 contains elements which enable to position the different elements of the thermodynamic machine with respect to one another. Partitions 29, 37, 31, and 39, or even partitions 45 and 47, may be formed by a spiral-shaped winding of one or several sheets around shaft 49. Elements providing the tightness, the thermal isolation, the mechanical hold, and/or the displacement of the different walls 33, 35, 41, and 43 in cylinder 21 are shown in FIG. 3 by hatched portions.

The presence of partitions 29 and 31 respectively attached to walls 33 and 35 in contact with the hot and cold sources enables to transmit heat into the entire volume of chambers 23 and 25. The reciprocating motion of partitions 37 and 39 plays a great part in this transmission.

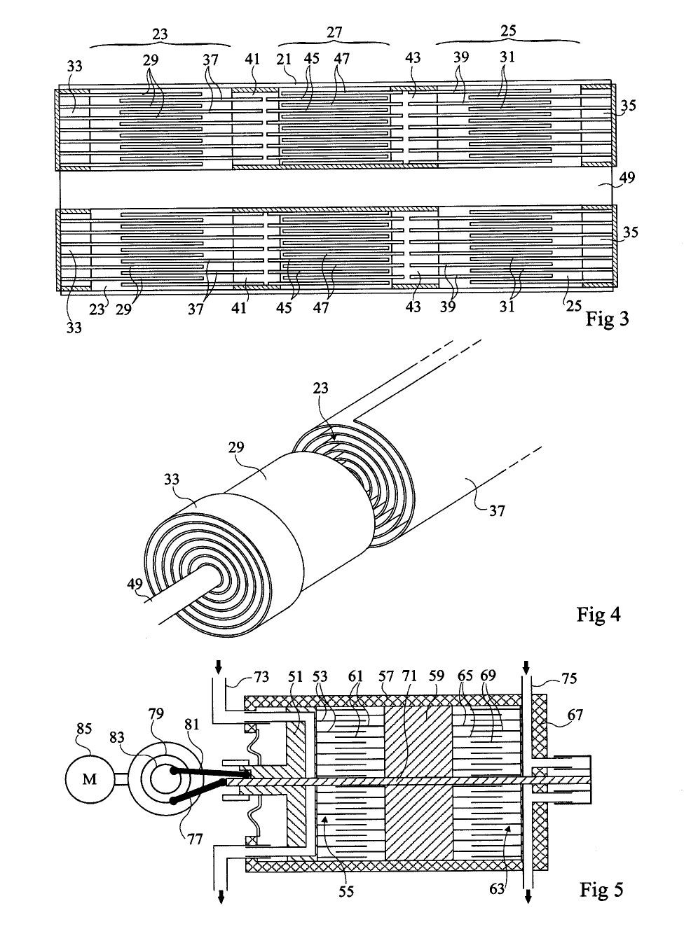

FIG. 4 is a perspective view illustrating a possible solution to form partitions in chamber 23 of the machine of FIG. 3. It should be noted that, in this drawing and in the followings, the number of spirals and the spacing between the different spirals are out of scale.

In FIG. 4, for simplification, the external cylinder in which the machine elements (21, FIG. 3) are moving is not shown. Further, the partitions delimiting the chamber have been shown as being distant from one another to make the understanding easier. In practice, the axial partitions extending from these walls are interleaved.

Chamber 23 is delimited by a first tight external wall 33, formed around axis 49, having partitions 29 extending from it. Wall 33 is provided to be placed in contact with a hot or cold heat transfer fluid, generally a liquid or a gas. In the shown example, partitions 29 and wall 33 are formed by winding, around axis 49, of strips of conductive materials. A wider strip forming partitions 29 and a thicker strip or several thin strips, forming wall 33 and ensuring the tightness of this wall, are wound around axis 49. A welding may be performed at the level of wall 33 to improve the tightness. On the other side of compression/expansion chamber 23 is formed a structure similar to structure 29/33, comprising an internal wall for separating the regenerator (not shown) having partitions 37 extending from it. Partitions 37 are also formed of a plate wound around axis 49, the wall for separating the regenerator associated with partitions 37 letting through the gas.

In this example, partitions 29 and 37 thus have spiral shapes in cross-section view in a plane perpendicular to the chamber length. A first spiral forms partitions 29 and a second spiral forms partitions 37, partitions 29 and 37 being provided to interleave as the volume of chamber 23 decreases.

The forming of interleaved exchangers enables to perform compressions and expansions at the same time as the thermal exchange with the hot/cold source. Temperature variations of the gas in the chamber are thus avoided, since each gas molecule is relatively close to a partition.

Moreover, to further improve exchanges in compression/ expansion chambers, the distance between partitions extending from a same wall is provided to be such that the ratio of this distance once squared to the thermodynamic machine cycle time is smaller than the average thermal diffusivity of the gas contained in the chamber. This gives time to the heat of the walls to diffuse into the entire gas volume in a compression/expansion cycle, without requiring turbulences (laminar state).

### 2. Mechanical Losses

In conventional machines, the compression of the gas is ensured by the power recovered in the expansion thereof. In a simple cycle, these two events do not occur simultaneously, which requires storing power, and then giving it back. This is generally performed by a flywheel or sometimes by electric power build-up.

Further, the power necessary to the compression is proportional to the absolute temperature during the compression. The power recovered during the expansion is also proportional to the absolute temperature during the expansion. The difference between the two temperatures defines the energy balance. If the power transmission is conventionally performed by an assembly of mechanical elements (connection rods, bearings, gears . . . ), these elements will sample a proportion of mechanical losses from the power that they transmit, proportionally to an absolute temperature.

To limit mechanical losses, it is provided to form a thermodynamic machine comprising several elementary Stirling cycle machines coupled in a specific manner.

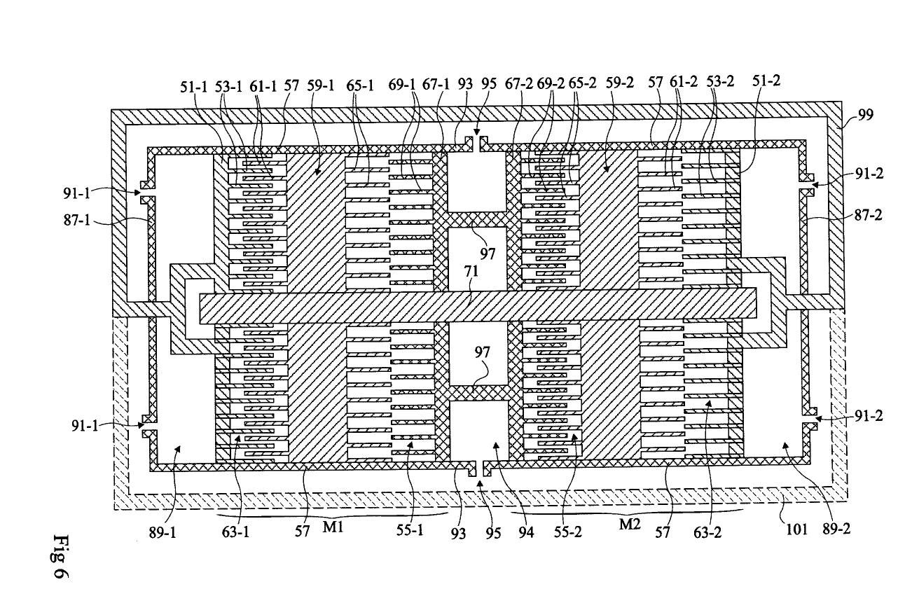

FIG. 5 is a simplified diagram of an elementary Stirling cycle machine and of its drive system according to an embodiment of the present invention. It should be noted that, in FIG. 5 and in the following drawings, pieces which move along are hatched in the same way.

The elementary machine comprises a first half-exchanger formed of an external wall 51 having axial partitions 53 extending from it in a first compression/expansion chamber 55. Wall 51 is mobile in a body 57 delimiting the machine contour (for example, cylindrical). A regenerator 59 is formed in body 57 and is mobile lengthwise (axially) therein. Regenerator 59, in chamber 55, has axial partitions 61 extending from it, intended to interleave with partitions 53. On the other side of the regenerator, in body 57, is formed a second compression/expansion chamber 63. Regenerator 59 has axial partitions 65 extending from it into chamber 63. A second half-exchanger, formed of an external wall 67 having axial partitions 69 extending from it into chamber 63, is fixed with respect to body 57. Partitions 69 are intended to interleave in chamber 63 with partitions 65. It should be noted that partitions 53, 61, 65, and 69 may be formed as described in relation with FIG. 4.

The different above-mentioned elements are formed around an axis 71, which is mobile with regenerator 59. A first fluid circulation circuit 73 (hot or cold source) is formed to cool down or to heat up wall 51, and thus partitions 53. A second fluid circulation circuit 75 (cold or hot source) is formed to cool down or to heat up wall 67, and thus partitions 69. Circuits 73 and 75 are provided to bring the cold or hot fluid as close as possible to chambers 55 and 63 (see hereinafter).

One end of axis 71 is connected to the foot of a connecting rod 77 having its head connected to a crankshaft 79. Mobile wall 51 is connected to the foot of a connecting rod 81 having its head connected to a crankshaft 83, and having the same axis as crankshaft 79. The heads of connecting rods 77 and 81 are coupled to crankshafts 81 and 83 in phase-shifted manner. Crankshafts 79 and 83 are associated with a motor M or alternator 85 (a motor in the case of a heat or cooling pump, an alternator for an operation in Stirling machine cycle).

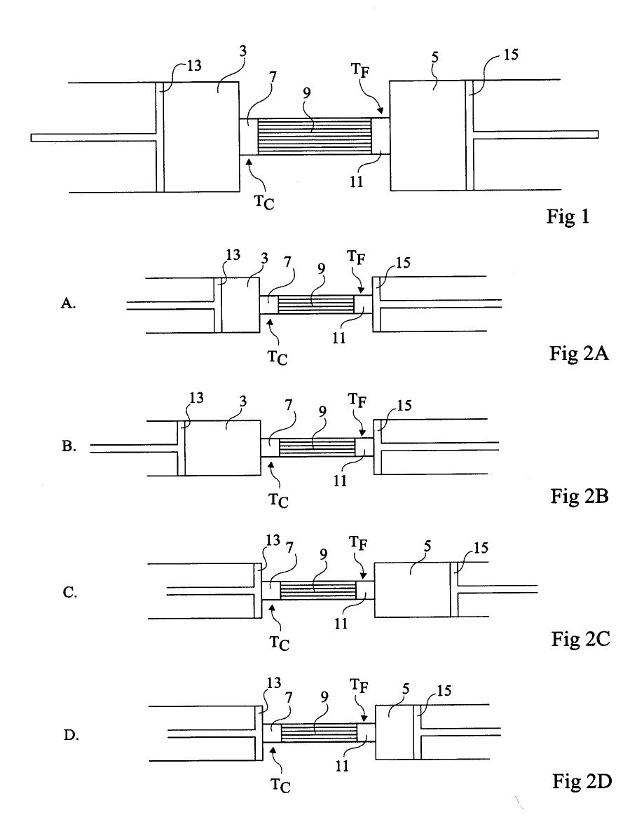

The operation of the machine of FIG. 5 is slightly different from the operation of the machine of FIG. 1 since, in this case, the regenerator is mobile in the machine (“mover-regenerator”). It should be noted that the mechanical system (connecting rods and crankshafts) shown in FIG. 5 is not limiting and that any mechanical system enabling to turn a translation into a rotation may be used, as long as the motions of axis 71 and of wall 67 are phase-shifted with respect to each other.

To limit losses in devices comprises Stirling cycle machines, an embodiment provides mechanically coupling, by a rigid connection, elements of two or several elementary machines such as that in FIG. 5.

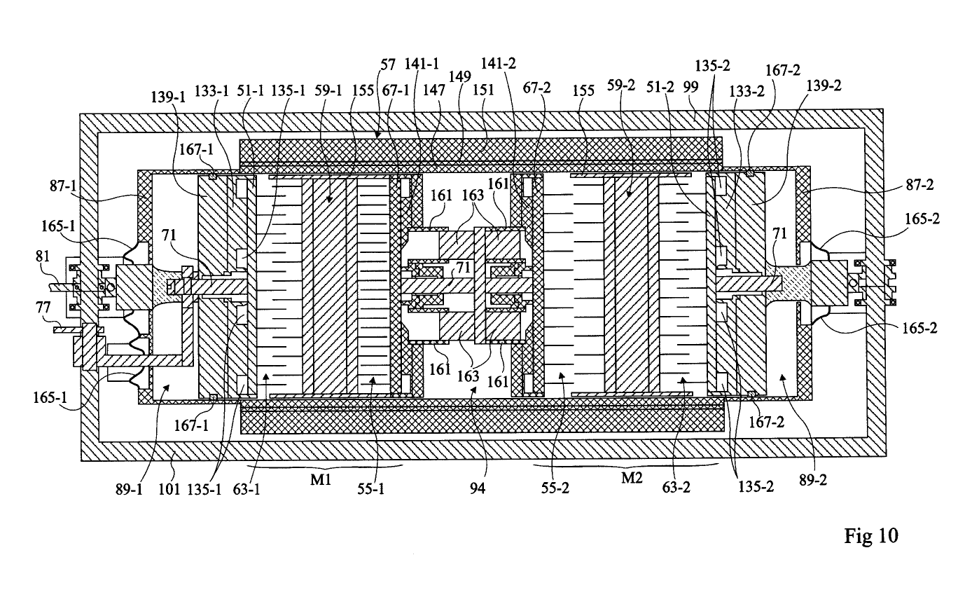

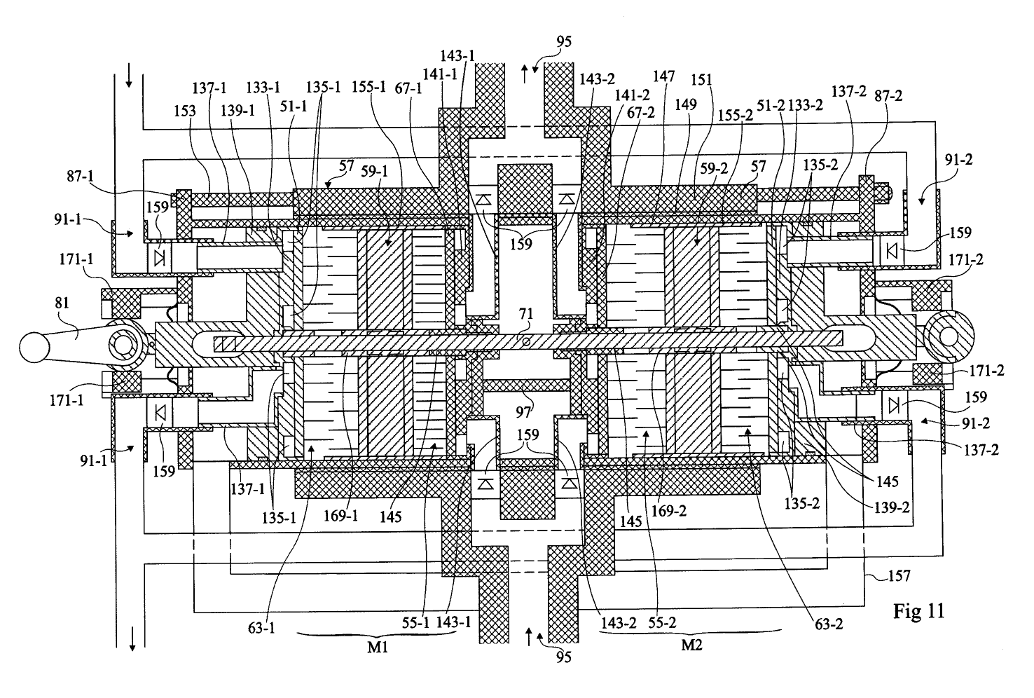

FIG. 6 is a partial simplified cross-section view illustrating an embodiment of a thermodynamic machine formed of two elementary machines associated with a single drive system. It should be noted that the circulation of the heat transfer fluids, shown in FIG. 5 but not discussed in detail, is not shown in FIG. 6. This circulation will be detailed in relation with FIGS. 10 and 11.

In FIG. 6, a device comprising two elementary machines M1 and M2 such as that illustrated in FIG. 5 is considered. In this drawing, reference numerals identical to those of FIG. 5 are used to describe machines M1 and M2, each reference numeral applied to machine M1 having an extension “−1” and each reference numeral applied to machine M2 having an extension “−2”. Further, for simplification, connections with a motor or alternator such as connections 77-79-81-83 of FIG. 5 are not shown in the drawing.

Elementary machines M1 and M2 are symmetrical with respect to each other and their contour is defined by a cylindrical body 57. Each elementary machine comprises a mobile regenerator 59-1, 59-2, not shown in detail, on either side of which are formed two compression/expansion chambers 63-1 and 55-1, 63-2 and 55-2. Axial partitions 61-1 and 65-1 extend, respectively, from regenerator 59-1, into chambers 63-1 and 55-1. Axial partitions 61-2, 65-2 extend, respectively, from regenerator 59-2, into chambers 63-2 and 55-2. Chamber 63-1, respectively 55-1, is delimited, opposite to regenerator 59-1, by an external wall 51-1, respectively 67-1, having axial partitions 53-1, respectively 69-1, extending from it. Chamber 63-2, respectively 55-2, is delimited, opposite to regenerator 59-2, by an external wall 51-2, respectively 67-2, having axial partitions 53-2, respectively 69-2, extending from it. Walls 67-1 and 67-2 are formed in front of each other in body 57. The elements of machines M1 and M2 are formed around a single central axis 71, regenerators 59-1 and 59-2 being solidly attached to this axis.

Body 57 closes chambers 63-1, 55-1, 63-2, and 55-2 and extends, on either side of each of the elementary machines, in portions 87-1, 87-2 defining back cavities 89-1, 89-2, opposite to chamber 63-1, 63-2 with respect to walls 51-1, 51-2. At least two openings 91-1, 91-2 are formed in extension 87-1, 87-2 to enable the flowing of a heat transfer fluid in cavities 89-1, 89-2 towards external walls 51-1, 51-2. Body 57 also comprises an extension 93 between the two elementary machines, between walls 67-1 and 67-2, to form a chamber 94. At least two openings 95 are formed in extension 93 to enable the flowing of a heat transfer fluid towards walls 67-1 and 67-2.

One or several rigid connections 97 are formed, in chamber 94, to interconnect walls 67-1 and 67-2, these walls being further solid with body 57. It should be noted that it is possible not to provide rigid connections 97, the holding in position of walls 67-1 and 67-2 being then ensured by body 57. A rigid connection is also formed between walls 51-2 and 51-1, outside of the body. The rigid connection is formed by a piece 99 solid with walls 51-1 and 51-2, which crosses extensions 87-1 and 87-2 of body 57 and extends outside of body 57. Thus, walls 51-1 and 51-2 are in direct mechanical connection. The connection formed between walls 51-1 and 51-2 may be strengthened with a second rigid piece 101 formed symmetrically with respect to rigid piece 99 outside of body 57.

It should be noted that the regenerators may, in addition to or instead of axis 71, be interconnected via external rigid bars similar to bars 99 and 101.

Thus, in a device such as that in FIG. 6, elements playing identical roles in the two elementary machines are interconnected by direct mechanical connections (regenerators, first mobile walls 51-1 and 51-2, and second fixed walls 67-1 and 67-2).

In the same way as in the elementary machine of FIG. 5, shaft 71 and walls 51-1 and 51-2 are connected to a device for turning a linear mechanical motion into a rotating motion, for example a system of connecting rods having a phase-shifted head rotation.

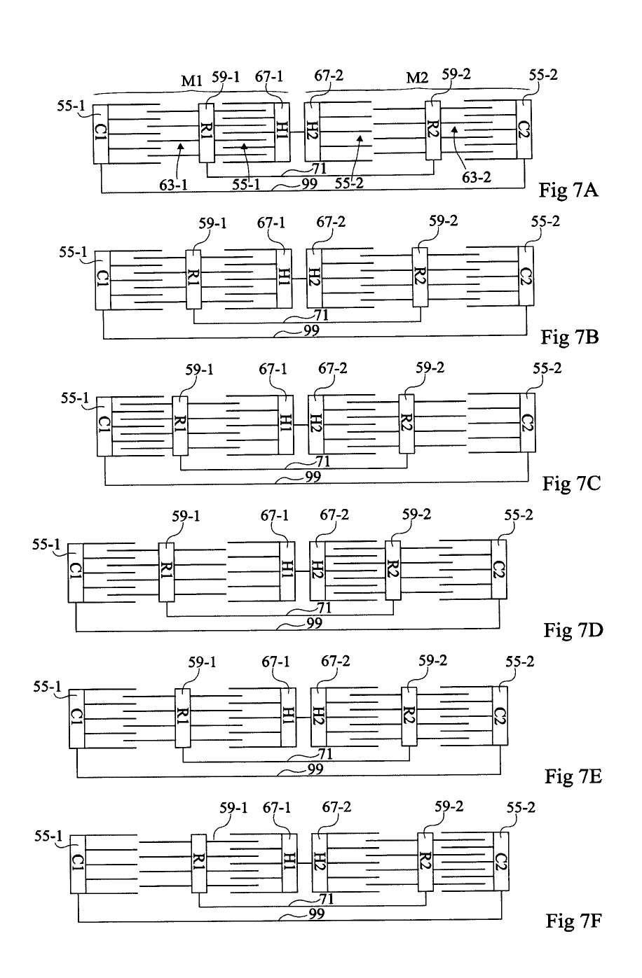

FIGS. 7A to 7F schematically illustrate the operation of the machine of FIG. 6 in an machine cycle in the case where openings 95 let through a hot heat transfer fluid and where openings 91-1 and 91-2 let through a cold heat transfer fluid. It should be noted that the motions of the mobile elements of the two machines are sinusoidal and that a slight deviation from the ideal cycle can thus be observed. However, the followed cycles remain cycles having the Carnot efficiency as a maximum theoretical efficiency.

At the step illustrated in FIG. 7A, machine M1 is at the end of an isothermal compression phase while machine M2 is at the end of an isothermal expansion phase, which results in regenerator 59-2 (R2) and wall 67-2 (H2) being the most distant from each other (the hot gas volume in machine M2 is the greatest) and regenerator 59-1 (R1) and wall 67-1 (H1) being the closest to each other (the hot gas volume in machine M1 is the smallest).

At the step illustrated in FIG. 7B, elementary machine M1 is in isochoric heating phase. The gas flows in regenerator (R1) of cold chamber 63-1 towards hot chamber 55-1 and the isothermal expansion on the hot source side starts. During this step, elementary machine M2 is in isochoric cooling phase. The gas starts from chamber 55-2 associated with the hot source to chamber 63-2 associated with the cold source.

At the step illustrated in FIG. 7C, machine M1 is at the beginning of an isothermal expansion phase while machine M2 is at the beginning of an isothermal compression phase, which results in the cold gas volume in machine M1 being the lowest (regenerator 59-1, R1, the closest to wall 55-1, C1) and in the cold gas volume in M2 being the highest (regenerator 59-2, R2, the most distant from wall 51-2, C2).

At the step illustrated in FIG. 7D, machine M1 is at the end of an isothermal expansion phase while machine M2 is at the end of an isothermal compression phase, which results in the hot gas volume in machine M1 being the highest (R1 the most distant from H1) and the hot gas volume in machine M2 being the lowest (R2 at closest to H2).

At the step illustrated in FIG. 7E, machine M1 is in isochoric cooling phase, and machine M2 is in isochoric heating phase.

At the step illustrated in FIG. 7F, machine M1 is at the beginning of an isothermal compression phase while machine M2 is at the beginning of an isothermal expansion phase (R1 and C1 are the most distant, R2 and C2 are the closest).

Thus, the two machines M1 and M2 have similar sinusoidal operations, in phase opposition. Advantageously, in a double machine, the expansion power recovered by the relative motion of regenerator 59 and of wall 67 is directly transmitted to the second machine to carry out the isothermal compression phase in this second machine. The presence of a rigid mechanical connection between the two regenerators and between walls 51-1 and 51-2 enables to avoid mechanical losses: indeed, since this connection is rigid, there is no friction or heating within this connection.

The power transmitted by the system rigidly connected, be it to a connecting-rod/crankshaft assembly, to a linear motor, or to any other motion transforming means, corresponds to the difference between the power necessary for the compression and the power provided by the expansion. A loss proportion, corresponding to the mechanical efficiency, is sampled from a power proportional to the difference between the absolute temperatures of the hot and cold sources, conversely to the conventional solution where this proportion is sampled from each power source, and thus proportional to each absolute temperature.

The double architecture thus enables the compression and the expansion to be simultaneous for a direct use of the power with no storage thereof. This enables to strongly decrease mechanical losses in the system with respect to conventional structures where two machines or more operate in phase opposition and are connected, by different connecting rods, to a same crankshaft and a same drive shaft. In this case, the mechanical power transits through the connecting rods and part of this power is lost. Further, the double architecture enables the central portion to have a better thermal isolation from the ambient air, as will be seen in relation with FIGS. 10 and 11.

### 3. Exchangers and Regenerator

A temperature difference between the heat transfer fluid and the exchanger walls also causes power losses. To limit such losses, it is desired to improve exchanges between heat transfer fluids and the walls, especially by using materials having a sufficient thermal conductivity and a properly-selected thickness.

Further, in the regenerator, a temperature difference between the internal exchange walls of the regenerator and the gas may also occur. This difference is all the greater as the thermal exchange between the walls and the gas is poor. A temperature difference, and thus losses, can also be observed, during a cycle, at the surface of the internal exchange walls of the regenerator: the wall is slightly cooled down by the gas as it first passes, then heated up. This effect is all the greater as the regenerator has a low thermal inertia. The temperature difference risks being increased if the cycle is fast and a “skin effect” appears at the surface of the exchange walls, the heat having no time to penetrate into these walls, and only the surface taking part in the regeneration function.

Further, the passing of the gas through the regenerator causes charge losses which must be minimized. Moreover, the material which forms the regenerator is itself poorly conductive and causes a direct heat conduction from the hot portion to the low portion. This loss must be minimized.

Finally, the heat transfer fluid flowrate is not infinite, and neither is its heat capacity. Thus, a temperature drop occurring between the flowing in and out of the heat transfer fluids causes losses in each exchanger. Such losses may be greatly decreased if the exchangers are formed by means of windings formed with spirals isolated from one another, the fluid circulation taking place radially at the contact of each exchanger. Further, if the regenerator is also formed of spirals isolated from one another, each portion of the gas then has a laminar reciprocating motion respectively in a spiral of same radius of the hot exchanger, of the regenerator, and of the cold exchanger. Each gas portion at a given radius from the axis then follows a Stirling cycle between two temperatures which vary according to the radius.

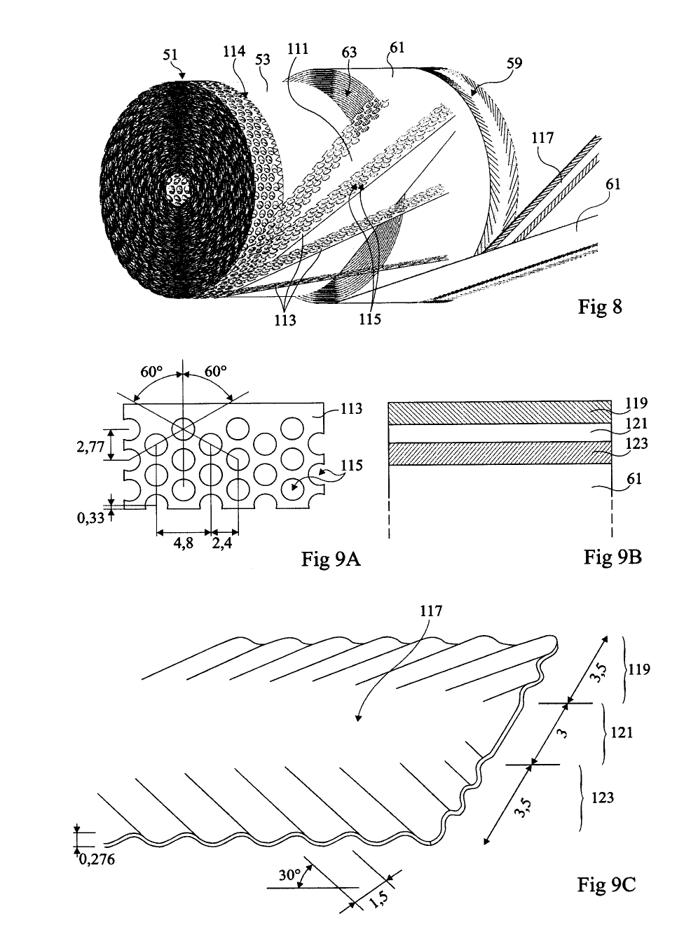

FIG. 8 illustrates an embodiment of two half-exchangers delimiting a compression/expansion chamber. FIGS. 9A to 9C illustrate in further detail portions of the half-exchangers of FIG. 8.

To favor heat exchanges between the hot and cold sources and the gas contained in each of the elementary machines, and to make heat exchanges between the compression and expansion chambers of an elementary machine easier, it is provided to form half-exchangers and regenerators in a particular way.

FIG. 8 is a perspective view of a structure of a compression/expansion chamber 63. In this drawing, for clarity, the machine body has not been shown. Chamber 63 is delimited by a first external wall 51 having axial partitions 53 extending from it into the chamber and by a second wall 59 associated with a regenerator. Wall 59 has axial partitions 61 extending from it into chamber 63. Partitions 53 and 61 face each other and are intended to interleave when the volume of chamber 63 decreases.

External wall 51 is intended to be placed in contact with a cold or hot source. To improve exchanges between wall 51, in contact with partitions 53, and the cold or hot fluid, it is provided to form this assembly in a particular way, by winding several strips together. A first wide strip 111, having one end forming partitions 53, is wound with one or several narrower strips 113 having their width corresponding to the width of wall 51. Strip(s) 113 are perforated with holes 115 across their entire width, except across a small width where the tightness between the working gas (in chamber 63) and the heat transfer fluid will be provided, as illustrated in FIG. 9A. Wide strip 111, having a portion forming partitions 53, is also perforated with several holes, but only across its width corresponding to the perforated width of strips 113.

The winding of strips 111 and 113 is provided so that, at the limit of chamber 63, the holes stop to ensure the tightness of chamber 63. To further improve this tightness, this end in contact with chamber 63 will be glued, soldered, or welded, for example, by means of a laser, after winding, to form the tight portion of chamber 63. Thus, the winding is porous at the level of the heat transfer fluid source and tight at the level of chamber 63.

The porous portion in strips 111 and 113 enables to have the heat transfer fluid flow as close as possible to chamber 63 and partitions 53. To let through the fluid, the holes are sized and positioned so that each hole of a given strip always emerges at the level of at least one hole in each strip that it contacts. Such a quincunx structure enables to ascertain that holes at different distances from the edge of the strips communicate. This enables the heat transfer fluid to easily penetrate into the porous thickness. Further, a row of holes is positioned on the edge of strips 111 and 113, on the heat transfer fluid side, to enable the fluid to penetrate into the porous structure.

The step between strip holes is selected so that no repetitive structure, which could adversely affect the fluid circulation, appears in the porous portion. For example, if the total thickness of the strips which are wound together is e, it will be avoided for the step of the pattern formed by the holes to be close to an integral multiple of πe. A significant diameter of the holes allows a good flowing of the cooling fluid, but this diameter must be selected to allow a good heat conduction by the material remaining around the holes.

FIG. 9A illustrates a strip 113 in which holes 115 are formed according to an adapted pattern. Holes 115 are formed on several lines along the strip length, in quincunx. As an example of numerical application in the case where the assembly of wound strips has a thickness e=0,552 mm, the holes 115 of a same line may be spaced apart by a distance ranging between 4.7 and 4.9 mm, preferably 4.8 mm. The holes of two adjacent lines have their centers located on an axis forming an angle of approximately 60° with respect to the strip width. Across the strip width, holes formed in two adjacent lines may be separated by a distance ranging between 1.3 and 1.4 mm (distance between two holes at the same level in the strip length ranging between 2.5 and 3 mm). Other dimensions are shown as an example in FIG. 9A.

The efficiency may also be improved if a temperature difference is maintained within the winding between the flowing in and out of the heat transfer fluid. In the case of a radial flow of the fluid (see hereinafter), the heat conductivity in the radial direction of the general structure is desired to be limited. To achieve this, it is provided to isolate the different strips of the spiral structure from one another, such an isolation further enabling to provide the assembly with the resilience which enables it to adapt to the expansion difference between the inside and the outside of the spiral. These two functions, that is, flexibility and isolation, may be achieved by means of a slightly flexible glue 114 providing a sufficient thermal isolation, at the limit of chamber 63 in the winding. For this purpose, the spirals may be welded by following a “zigzag” pattern 114 or by following a sinusoid comprised within the width of the non-perforated portion of the wound strips, the step of the sinusoid complying with the same condition as the steps between holes (different from a multiple of πe).

The points where the weldings of two layers superpose provide the rigidity and the accuracy of the angular positioning of each strip, which positioning is necessary to maintain the dimensions of the winding, while the points where the weldings of two layers are not superposed enable to provide for the layers not to be totally contiguous, which enables to thermally isolate the layers and to provide flexibility in the radial direction to absorb expansions.

It should be noted that the above-described exchange wall structure applies to the different external exchange walls of the machine of FIG. 5, that is, to walls 51 and 67.

To minimize the difference sources of losses in regenerators, a specific structure of the regenerators, partially illustrated in FIGS. 8, 9B, and 9C, is also provided. The regenerator is formed in a thermally insulating material, having a sufficient thermal effusivity and a sufficient thermal inertia to avoid temperature variations during a cycle.

The regenerator is delimited by two external walls (see FIGS. 10 to 12), a single one of these walls (reference 59) being illustrated in FIG. 8. From these walls, axial partitions 61 and 65 extend into compression/expansion chambers 63 and 55.

To form a regenerator, it is provided to form a winding of several strips, a first wide strip being intended to form partitions 61 of the exchanger, and one or several narrower second strips 117, to let through the gas, and ensuring the holding of the structure, and the forming of the regenerator wall. A third strip, similar to the first one, may be provided in the same winding or shifted from it to form the internal regenerator walls (not shown). As shown in FIGS. 8, 9B, and 9C, thin strip(s) 117 and a portion of the wide strips located in the winding at the level of the thin strip are deformed.

FIG. 9B illustrates the deformation of the strip forming partitions 61, at the level of its portion intended to be wound with narrower strip(s) 117. Strip 61 comprises, across the width of this portion, and along its entire length, a sequence of three areas 119, 121, and 123. Area 119, closest to the regenerator, is corrugated, the corrugations being oblique with respect to the length of strip 61. Central area 121 is planar and area 123, which is the closest to chamber 63, is corrugated, the corrugations being oblique, symmetrically with respect to the corrugations of area 119.

In the same way, strip 117 comprises, across its width, three areas, the first one being corrugated, the second one being planar, and the third one also being corrugated, the corrugations of the first and third areas being oblique in different directions. The winding of strips 61 and 117 is provided so that corrugations which superpose are oblique in different directions. This enables to obtain a constant distance between walls 61 in chamber 63, and enables gas to flow in the regenerator. As an example, the different corrugated areas may be formed by drawing.

FIG. 9C illustrates an example of possible dimensions for the corrugations of the corrugated portions of strip 117 (which are identical, symmetrically, to the corrugations of strip 61). As an example, the first and third corrugated areas may be formed across a width on the order of 3.5 mm and the second planar area may extend across a width on the order of 3 mm. The corrugations of the first and third areas may have a 0.276-mm clearance across the thickness, and form a 30° angle with the strip length (symmetrically for the first and third portions).

In the same way as partitions 61, to limit losses in the regenerator, the partitions internal to the regenerator (45 and 47) extend therein by being interleaved, the interleaving being made possible by the presence of the corrugations on the end of the internal partitions at the location where they are held on the walls.

The gas thus flows in the quasi-planar spaces formed by the successive layers of the spirals. The geometry results in a gas circulation (between two planes or quasi-planes) in the regenerator which enables to maximize the ratio of the Nusselt number to the friction coefficient in laminar state (which state is inevitable, given the dimensions and the gas speeds). Thermal exchanges are thus maximized in the regenerator, while losses by viscous friction are minimized.

The material forming the regenerator elements is a poor heat conductor to avoid a direct heat conduction between the hot and cold sources, the heat capacity of the assembly being sufficient to avoid for the temperatures inside the regenerator to vary too much during the cycle. Finally, the thermal diffusivity of the material is sufficient to enable the entire bulk of the material to be involved in the thermal exchange during a cycle and avoid a “skin effect” in the material, which would imply temperature variations of the walls during a cycle. For example, to comply with these different conditions, it may be chosen to make the regenerators in rollable plastic materials or in sheets based on mineral fibers.

It should be noted that, to ease the winding of the different strips forming the exchanger walls, one or both end of wide strip 61 may be cut with an oblique angle to avoid a deformation of the winding, for example, at 45° with respect to the strip length. The same applies for strip 111.

### 4. Circulation of the Heat Transfer Fluid in the Back Chambers

FIGS. 10 and 11 are two more detailed cross-section views of a machine formed of two elementary machines according to an embodiment of the present invention, and elements enabling to limit losses in such machines. It should be noted that, in these drawings, the structure of the regenerators has not been shown in detail and that the partitions formed in the compression/expansion chambers are shown as an illustration, and are out of scale.

The thermodynamic machine of FIGS. 10 and 11 comprises two elementary machines M1 and M2. In these drawings, reference numerals identical to the reference numerals used in relation with FIG. 6 for already-described elements have been used. Thus, each elementary machine M1 and M2 comprises a first and a second chamber 55, 63, separated on one side by a fixed regenerator 59 on an axis 71 and on another side by an external wall 51, 67. Axis 71 extends all along the machine (see FIG. 11). Interleaved axial partitions extend in each of the chambers. Outside of the elementary machines, a chamber 89 is formed, opposite to chamber 63 with respect to wall 51, by an extension 87 of body 57 of the machine. Chamber 89 is intended to receive a first heat transfer fluid. Body 57 is also closed between the two elementary machines to form a chamber 94 located between walls 67-1 and 67-2 and intended to receive a second heat transfer fluid. In the description of FIGS. 10 and 11, for simplification, the first heat transfer fluid will be considered as being the cold fluid and the second heat transfer fluid will be considered as being the hot fluid (that is, hot with respect to the cold fluid). Of course, the opposite is also possible.

To guide the circulation of the heat transfer fluids in the porous portions of walls 51-1 and 51-2, it is provided to form pieces 133-1, respectively 133-2, along walls 51-1, respectively 51-2, in chambers 89-1, respectively 89-2. These pieces move along with walls 51-1 and 51-2.

Preferably, in the case of the use of an aqueous heat transfer fluid, pieces 133-1 and 133-2 are electrically insulating to avoid any corrosion due to the contact of the cooling fluid with two metals of very different natures in electric contact with each other. Pieces 133-1 and 133-2 enable to organize the circulation of the heat transfer fluid in the porous portion of external walls 51-1 and 51-2 (see FIG. 8).

Each piece 133-1, 133-2 is provided with channels 135-1, 135-2 which enable the fluid to circulate along wall 51-1, 51-2. For example, a first external circular channel may be provided on the periphery of wall 51, enabling the cold fluid to flow in and a second circular channel may be provided close to axis 71 of the structure to enable the cold fluid to flow out. Thus, pieces 133-1, 133-2 enable the heat transfer fluid to be brought in contact with the entire surface of wall 51-1, respectively 51-2, according to a radial circulation in the porous portion.

As can be seen in FIG. 11, the heat transfer fluid coming from a cold source flows in and out of channels 135-1 and 135-2 via fluid circulation lines 137-1, 137-2, solidly attached to piece 133-1, 133-2, which slide in fluid inlet and outlet line 91-1, 91-2 as walls 51-1, 51-2 move. Pistons 139-1, 139-2, moving along with pieces 133-1, 133-2, are connected to external rigid bars 99 and 101 so that walls 51-1 and 51-2 always move along with each other and are crossed by lines 137-1 and 137-2. It should be noted that the cold fluid inlet for the two elementary machines may be formed of a single fluid inlet which separates between the two machines to reach fluid inlets 91-1 and 91-2 (see FIG. 11).

Similarly, at the level of back chamber 94, pieces 141-1, 141-2 similar to pieces 133-1, 133-2, which are fixed with respect to body 57, are formed along walls 67-1 and 67-2, such pieces comprising channels similar to channels 135 enabling the hot fluid to flow in and out. Lines 143-1 and 143-2 are formed in chamber 94 to bring the hot fluid into the channels through the body.

Rings 145 are provided around axis 71, at the level of parts 133 and 141 and of walls 51 and 67, to ensure the tightness at the level of axis 71. Rings 145 may be made of an electrically insulating material to avoid an electric contact between the exchanger and the rest of the structure, and for example to enable, by electric contact measurement, to detect an incidental contact between interleaved half-exchangers.

### 5. Machine Body

To limit such losses, it is desired to form as insulating a body as possible, at least at the level of each of the elementary machines. The body performs several functions: thermally isolating the hot and cold sources from each other, thermally isolating a source from the ambient air, ensuring the mechanical hold against the working gas pressure by accepting tangential stress, ensuring the mechanical hold against the working gas pressure by accepting axial stress, and ensuring the working gas tightness, especially in the case where the working gas is hydrogen or helium.

Since there is no material enabling to perform all these functions at reasonable costs, not to mention that part of the wall may be submitted to high temperatures, it is provided to form the body in a stack of several layers, each enabling to carry out one or several of these functions.

Thus, a first portion of the body, not shown in the drawings, in contact with the working gas, may be formed of a thin layer that may be thermally conductive, with a low permeability and a good behavior with gases, for example, aluminum or preferably a stainless steel in the case where hydrogen is used as a working gas. Its fineness prevents any direct heat conduction between sources (typically on the order of one millimeter, or even smaller). Around the thin layer is formed a layer 147 of a material which is a poor heat conductor having an insufficient mechanical strength to withstand the internal pressure of the working gas alone (for example, a plastic such as polyoxymethylene, a polyamide, a polyimide, a poly-x-sulfone, or mixtures based on resins and on mineral fibers). The low heat conduction of layer 147 enables to avoid any direct heat conduction between the sources.

Around layer 147 are formed metal circles 149 ensuring the mechanical hold and possibly being heat conductors. To provide such a mechanical hold, they are preferably paced apart from one another by a small distance as compared with the thickness of layer 147. The multitude of spacings between successive circles (not shown) enables to avoid any direct heat conduction between sources.

Around circles 149 is formed a thermal isolation layer 151. Conversely to the other layers, it must limit the heat transfer between the inside and the outside of the body, perpendicularly to the structure, the other layers limiting the heat transfer along the length of the structure. As can be seen in FIG. 11, thermal isolation 151 continues along the inlet and the outlet of hot heat transfer fluid. For example, layer 151 may be made of a mineral wool.

Tie rods 153, held in position by washers and bolts at the ends of the body (a single one being shown), may be provided to ensure the holding of the assembly along the machine length (conversely to strappings 149 which provide a mechanical hold against pressure in the direction tangential to the machine).

### 6. Losses Due to Displacements

To limit losses, in each of the elementary machines, by direct conduction between the compression/expansion chambers due to the displacement of the regenerator assembly along the walls, it is provided to form a substantially cylindrical piece 155, all around the regenerator. Piece 155, which is isolating, moves along with regenerator 59 and is provided with an infrared reflective coating. Piece 155 is in contact with the body along part of its length to ensure the relative tightness between the compression/expansion chambers and limit direct heat transfers between the chambers. A spacing, provided along the rest of its length between piece 155 and the body enables to limit losses due to the displacement. Piece 155 may be made in the form of two nested isolated cylinders under vacuum to decrease its heat conductivity widthwise.

### 7. Back Volume Losses

Back volume losses are due to the compression and expansion of the gas volume located to the back of the pistons in back chambers 89-1 and 89-2. Since the compression is not perfectly adiabatic, it results in losses. If the back of the pistons is open, the losses correspond to the losses associated with the emission of sound waves (generally infrasonic for this type of machine).

To limit such losses, it is provided to put volumes 89-1, 89-2 located to the back of pistons 139-1 and 139-2 in communication. This enables the variation of one of these volumes to exactly compensate for the variation of the other volume. Thus, there is no further compression/expansion cycle for the volume located to the back of the pistons and losses are decreased. This solution is shown in FIG. 11 where a duct 157 connects back chambers 89-1 and 89-2. This structure almost enables to cancel back volume losses and to decrease the sound emission.

### 8. Integrated Fluid Circulation

To further limit losses in the system, it is desired to use the motion of the different machine elements to perform the pumping of the heat transfer fluids at the level of the hot source.

To achieve this, it is provided to form, in the different fluid inlet and outlet tubes, check valves 159 in the fluid circulation direction, on either side of the machine. It is further provided to attach to the machine body, in chamber 94, fixed tubes 161 in contact with the channels closest to axis 71 in pieces 141-1 and 141-2.

The circulation in fixed walls 67 may advantageously be achieved by an integrated piston pumping solution, said pistons being in rigid mechanical connection with the motion of regenerators 59-1 and 59-2 (or again, in a case not shown, with the motion of pistons 139-1 and 139-2). Pistons 163 mobile with axis 71 (connected to the regenerators), penetrating into the different tubes 161, enable to pump heat transfer fluid during the motion of axis 71. They are preferably symmetrically distributed around the axis, for example, two symmetrical pistons are provided, to balance forces and provide an action with no parasitic torque on the axis and its guides.

Thus, when the regenerators are moving, this actuates pistons 163 in tubes 161 and allows, in each elementary machine, the pumping and the expulsion of the hot heat transfer fluid in adapted fashion.

Similarly, on the side of mobile pistons 139, the piston motion may be used to create volume variations in heat transfer fluid inlet and outlet tubes 137. In this case, part of tubes 137 is parallel to the motion of the mobile pistons and the length of these tubes varies along with the piston motion. In the example shown in FIG. 11, two tubes 137 slide in each other to provide this length variation. It may also be provided to form bellows in these tubes to obtain an identical effect.

Lines 91-1 and 91-2 are supplied in parallel by a common duct. The fluid pumping and expulsion in each elementary machine is thus performed in phase opposition, the volume variations of the heat transfer fluid exactly compensating for each other. This enables to ascertain that the pumping is performed with no variation of the total volume of the heat transfer fluid circuit.

The machine speed being proportional to the sampled thermal power and the necessary flowrate of the fluid being also proportional to this power, a volumetric pumping enables to provide an operation with constant temperature differences. The direct mechanical transmission enables to avoid mechanical losses and any loss and additional cost due to the installation of a fluid circulation pump (with its power supply, machine . . . ). This thus altogether provide low losses, simplicity (no need to regulate), and a structurally optimal operation.

### 9. Losses Due to the Sealing

Dynamic sealings cause friction. To limit such losses, a mini-leak provided when piston 139-1, 139-2 is in a given position, for example, the most distant from regenerator 59, enables to pump unforeseen leaks in the other direction during the cycle and to limit the stress on dynamic sealings. This leak enables to determine the time in the cycle when pressures are equal on either side of the piston, for example, when the piston is in the position where the working gas has a maximum volume. The rest of the motion enables to pump uncontrolled leaks which would have occurred during the cycle in the reverse direction. The stress on such sealings is thus relieved.

To obtain this leak, a small notch (not shown) may be formed in body 57, in chamber 89-1 and 89-2, at the level of piston 139-1, 139-2 when chamber 89-1, 89-2 has the smallest volume. Further, to provide the tightness of the assembly, a rolling sleeve diaphragm or bellows 165-1, 165-2 may be provided along shaft 71, at the level of the extension of body 87-1, 87-2. It should be noted that such a diaphragm or bellows may be omitted if the entire machine, possibly with its electronics included, is comprised within a tight assembly. The diaphragms or bellows may possibly be double, for example, to detect a heavy leak by means of a system for detecting the presence of gas between the two walls.

Further, seals 167-1, 167-2 may be formed around pistons 139-1, 139-2 to provide a dynamic sealing at their periphery. Seals, not referenced in the drawings, may also be provided at the level of the regenerator assembly guides, around shaft 71, and at the level of pistons 139-1 and 139-2 mobile in ducts 91-1 and 91-2, at the level of the integrated heat transfer fluid circulation. It should be noted that these last seals may be replaced with bellows.

### 10. Pressure Balancing

A system for balancing the working gas pressure in each of the compression/expansion chambers, comprising a valve enabling to switch the ratio of the speed to the thermal power to adjust the operating conditions, in particular if one of the parameters (such as speed) is set (for example, by another coupled machine), may also be provided. To achieve this, pressure sensors will be provided in the chambers to obtain the instantaneous working gas pressure, and in a reserve formed outside of the machine.

To increase the working pressure, the valve will be opened at the time of the cycle when the instantaneous pressure of the working gas is lower than that of the reserve, and conversely. As a variation, two valves and check valves may be used, the check seats being at closest to the inside of the machine to avoid dead volumes.

Further, in the case where the working fluid is hydrogen and where irreversible gas microleaks appear through the walls or the diaphragms, it may be provided to couple the pressure balancing system with a gas injection microsystem, for example a mini electrochemical cell, to block microleaks.

### 11. Losses Due to the Guiding

For the spirals to properly interleave in the compression/expansion chambers, a guiding is necessary. This guiding could be performed by direct contact between the loops of two spirals intended to interleave, but this possibility offhand excludes materials such as aluminum, which has poorly adapted tribological properties. Further, a guiding from the outside of the machine is difficult: large diameters, in relation with the expected differential expansions between the piston and the body (different materials and/or thermal transients) require significant functional clearances proportional to the diameter.

To enable the spirals to properly interleave, a guiding on small diameters, close to the axis of the spirals, is desired to be performed. A very small clearance at the diameter (maximum 0.02 mm) enables to accurately guide the spirals.

To achieve this, spiral 51-1, 51-2, in contact with the pistons, may be wound on a mandrel (not shown) used as a guide and further providing a relative tightness. The mandrel may be screwed on shaft 71 by an electrically insulating ring to avoid corrosion (not shown). The two spirals forming the half-exchangers running on either side of the regenerator may be wound on two aligned mandrels 169-1 and 169-2 and maintained by a thermally isolating ring (not shown) on which the regenerator may itself be wound. Finally, the fixed spiral forming the fixed half-exchanger (hot side) may be wound on a mandrel having a guiding axis fixed and aligned on it.

Thereby, the relative guiding of the two spirals interleaved in a compression/expansion chamber on the piston side is provided by the sliding of the mandrel connected to the piston on the axis connected to the mandrel, and the relative guiding of the interleaved spirals of the other chamber is provided by the sliding of the mandrel axis on the guiding axis.

Further, the parasitic torques which would be exerted on the elements are desired to be limited to have a balanced mechanical system. The torques exerted on the piston surfaces are low; indeed, the spiral structure results in a pressure balancing between each half-turn of the spiral, even in case of a temperature difference between half-spirals. Thus, the pressure amounts to a force centered on the middle of the spiral.

However, this force transmits onto the connecting rod and a portion thereof turns into a significant effort in the radial direction, which might cause a torque on the axis. This effort may uneasily be borne by the guiding axis and must thus be taken charge of by the body or by an element rigidly connected to the body. To avoid this, low-friction guiding means are used (rolling bearings, rollers, drawn cup ball bearings).

Generally, to limit guiding losses, a sliding or rolling joint may be provided on a plane between an intermediate piston and pistons 139-1 and 139-2, the plane being perpendicular to the guiding axis, the point of application of the force being between the piston and the intermediate piston being located on the guiding axis. This plane may also be an arc of a sphere centered on mandrel 169. This intermediate piston may be pre-guided by a rolling bearing. Thus, the efforts due to the connecting rod which are not in the piston axis are taken charge of by the body, for example, by an extension 171-1, 171-2 of the body formed on either side of the foot of connecting rod 81 associated with pistons 139. Advantageously, a rolling bearing joint has a very low friction coefficient, which enables to limit losses due to such efforts. Thus, most of the drive force exerted on pistons 139-1, 139-2 follows the guide axis, which avoids for a prejudicial torque to appear at the guiding level.

Further, other guiding pieces may be added to the machine, for example, at the level of two spirals of the hot expansion chamber. In the case where the source located at the center of the machine would be too hot a source for the guiding and the sealing to be easy, the guiding is performed in the cold portion, and a guiding piece around the shaft enables to transmit the guiding to the hot portion via a thermally isolating piece.

### 12. Association of More Than Two Machines

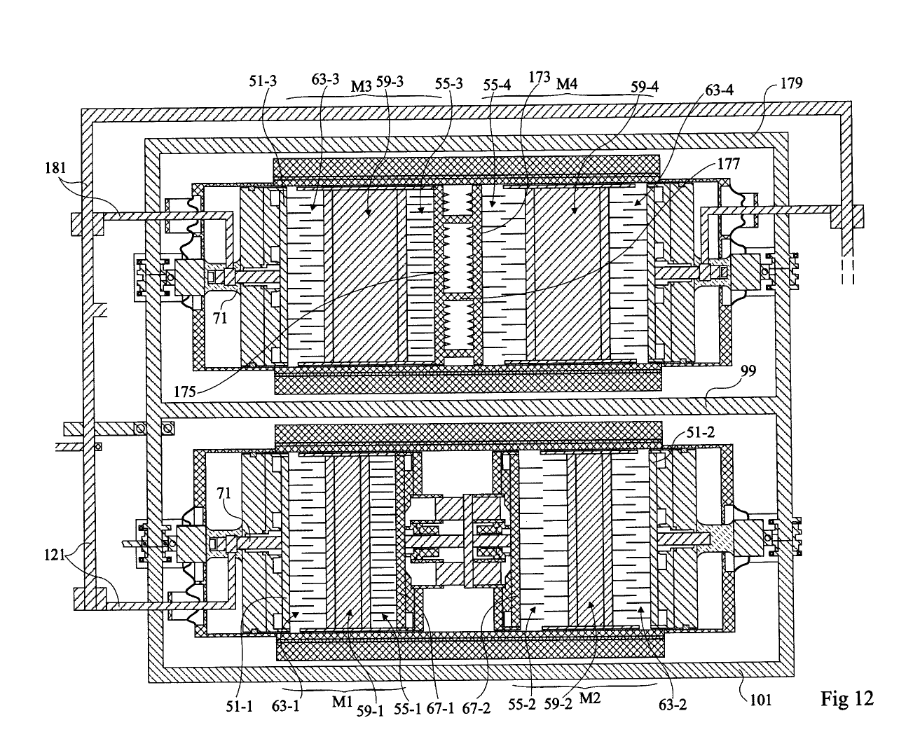

FIG. 12 illustrates a thermodynamic machine comprising two machines, each formed of two elementary Stirling cycle machines.

A first double machine comprises two elementary machines M1 and M2 formed similarly to the machine illustrated in FIGS. 10 and 11. This first machine will not be described in detail again. A second machine formed of two elementary machines M3 and M4 (reference numerals followed by “−3” and “−4” for elements similar to elementary machines M2 and M3) is formed in parallel with the first machine. The second machine is similar to the first machine except that, in the central portion of the machine, rather than providing a hot fluid circulation circuit, a combustion chamber 173 is formed in the machine enclosure (at the level of chamber 94 of the first machine).

The central temperature of the second machine is thus higher than the central temperature of the first machine. On either side of combustion chamber 173 are formed elements similar to those of the first machine, that is, combustion/expansion chambers separated by regenerators and walls/pistons. On the hot side of the second machine, no circulation is direct and the combustion chamber is supplied with reactants which are conventionally introduced by pumps, not shown. These pumps may for example be connected to the drive shaft by a conventional mechanical transmission (gear, chain, strap . . . ) or be associated with an electric motor powered by an alternator.

Combustion chamber 173 may be equipped with elements 175 capable of improving heat exchanges with its walls (for example, fins of exchange with the gases extending in the combustion chamber) and may be equipped with elements 177 capable of improving the mechanical resistance to the pressure difference of working gases in the two half-machines (strengthening bars, for example).

The general principle is to ascertain that the mechanical power provided by a machine is directly used by other machines. To achieve this, a rigid mechanical connection between the different machines enables to directly transmit the mechanical power, with no loss. Thus, rigid bar(s) 99 and 101 are connected to similar rigid bars connected to pistons and external walls of the second machine. An additional rigid bar 179 may be formed on the other side of the second machine to balance the torques applied to this machine.

It should be noted that the shown regenerators have greater lengths in the second machine (M3, M4) than in the first machine. Indeed, in each cycle, these regenerators must recover from and give back to the gas a power proportional to the temperature difference between sources. This temperature difference is assumed to be greater in this case, which results in the presence of a longer regenerator.

Further, in the shown example, the regenerators of the two machines are also interconnected. For this purpose, shafts 71 of the two machines are interconnected by an external rigid bar 181. To balance torques, rigid bar 181 may be double and may be formed on either side of shafts 71 and connect back outside of the machine.

The other elements of FIG. 12 are identical to those which have been described in relation with FIGS. 10 and 11. In the shown application, the first machine (low temperature) may operate as a heat pump, the isolated central portion being equipped with an integrated heat transfer fluid circulation system in contact with the cold source (for example, geothermal ground pipes). The hot central portion may be a biomass combustion area, and the heat transfer fluids which flow in the external parts of machines equipped with integrated circulations may be connected to a device for transferring the heat generated in a heating installation, for example, heaters or a heating floor).

Thus, part of the heat generated by the combustion enables to generate mechanical power in the second machine, this mechanical power being used to operate the first machine as a heating pump through a loss-free rigid mechanical connection. This absence of any loss provides a high performance coefficient for the heating pump portion, and thus enables to significantly increase the obtained heating power for a same fuel consumption. The transmitted powers may be set by adjustment of the working gas pressures. Part of the power may also be sampled for a combined heat and power production function.

Identical applications may thus be coupled, not for the sake of efficiency, but to operate several machines with a single connecting rod assembly or drive system enabling to generate a linear motion (like a linear motor). Machines carrying out different functions may also be coupled, as shown in FIG. 12.

Specific embodiments of the present invention have been described. Various alterations and modifications will occur to those skilled in the art. In particular, it should be noted that no example of hot and cold sources has been described in detail herein. In a domestic integration, the cold source may for example be a source of geothermal origin and the hot source may be a source connected, for example, to a heating floor.

1. A thermodynamic engine formed of at least one assembly of two elementary Stirling cycle engines (M1, M2) formed symmetrically in one or several cylindrical bodies of same axis (57), each elementary engine comprising first and second compression/expansion chambers (55, 63), a regenerator (59) separating the first and second chambers and first and second external walls (67, 51) intended to close the volume, respectively, of the first and second chambers, the regenerator, the first external wall and the second external wall of an elementary engine being rigidly connected to the same elements of the other elementary engines.

2. The thermodynamic engine of claim 1, wherein each first external wall (51) is mobile in the body (57), each second external wall (67) is fixed with respect to the body, and each regenerator (59) is mobile in the body.

3. The thermodynamic engine of claim 1, wherein two regenerators (59) of two elementary engines formed in a same body (57) are interconnected via an axis (71) located at the center of the body and the first external walls (51) are rigidly interconnected via one or several bars (99, 101) extending outside of the body.

4. The thermodynamic engine of claim 1, wherein the first and second compression/expansion chambers (55, 63) are divided by first and second partitions (53, 61, 65, 69) axially extending, respectively, from the associated external wall (51, 67) and from the regenerator (59), the first and second partitions becoming interleaved in the relative motions between said first and second partitions.

5. The thermodynamic engine of claim 4, wherein the assembly formed of an external wall (51, 67) and of the associated partitions (53, 69) is formed by winding of a wide strip (111) and of at least one narrower strip (113) having a width corresponding to the width of the external walls, the narrower strip being perforated along its entire width except where it is in contact with the chamber, the wide strip being perforated on its portion located at the level of the perforated width of the narrower strip.

6. The thermodynamic engine of claim 5, further comprising pieces (133, 141) associated with the first and second walls (51, 67), outside of the compression/expansion chambers (55, 63), in which channels (135) enabling to bring a heat transfer fluid into the holes formed in said winding are defined.

7. The thermodynamic engine of any of claim 1, wherein each regenerator (59) is delimited by two permeable internal walls (41, 43) from which partitions (45, 47) axially extend into the regenerator enclosure, each internal wall and its associated partitions being formed by winding of a wide strip and of at least one narrower strip having a width corresponding to the width of the regenerator walls, the narrower strip comprising, widthwise, a first corrugated area having oblique corrugations with respect to the strip length, a second planar area, and a third corrugated area having oblique corrugations with respect to the strip length in a direction opposite to the corrugations of the first area, the wide strip comprising, opposite to the first and third areas of the narrower strip in the winding, corrugated areas having oblique corrugations with respect to the length of the wide strip, in a reverse direction with respect to the corrugations of the narrower strip.

8. The thermodynamic engine of claim 1, wherein each elementary engine further comprises a cylindrical piece (155) mobile with the regenerator (59) formed around the regenerator in the body (57).

9. The thermodynamic engine of claim 1, wherein the body comprises extensions (87) delimiting first back chambers (89) of each elementary engine, opposite to the second compression/expansion chambers (63) with respect to the first external walls (51), the back chambers (89) of each elementary engine being in direct communication through a duct (157).

10. The thermodynamic engine of claim 9, wherein a first heat transfer fluid flows in and out of each first back chamber via ducts (91) in which check valves (159) are formed in the direction of circulation of the first heat transfer fluid, the motion of the first external walls (51) with respect to the ducts ensuring the pumping of the heat transfer fluid into the ducts.

11. The thermodynamic engine of claim 1, wherein the body (57) comprises an extension (93) delimiting a second back chamber (94), opposite to the second chambers (55) with respect to the second external walls (67).

12. The thermodynamic engine of claim 11, wherein a second heat transfer fluid flows in and out of the second back chamber via ducts (95) in which check valves (159) are formed in the flow direction of the second heat transfer fluid.

13. The thermodynamic engine of claim 11, comprising a combustion chamber (173) in the second back chamber (94), in contact with the second external walls (67).

14. The thermodynamic engine of claim 1, wherein the first external walls (51) are rigidly connected to the foot of a first connecting rod (81) having its head associated with a first crankshaft (83) and the regenerators (59) are rigidly connected to the foot of a second connecting rod (77) having its head associated with a second crankshaft (79), the first and second crankshafts being formed around a same axis.
